(19) United States
(12) Patent Application Publication
(10) Pub. No.: US 2015/0167380 A1
(43) Pub. Date: Jun. 18, 2015

(54) Window Blind Apparatus

(71) Applicant: Michael Farley, Peterborough (CA)

(72) Inventor: Michael Farley, Peterborough (CA)

(21) Appl. No.: 14/565,779

(22) Filed: Dec. 10, 2014

Related U.S. Application Data
(60) Provisional application No. 61/915,023, filed on Dec. 12, 2013.

(51) Int. Cl. E06B 9/303

(52) U.S. Cl. CPC E06B 9/303

(57) ABSTRACT

A window blind apparatus that serves to block light while allowing air to pass therethrough. The window blind apparatus includes a number of elongated slats disposed horizontally and that are arranged in a stacked orientation on top of one another. The slats are spaced at fixed intervals and are connected by support cables that extend through apertures on each of the slats. The slats have a zig-zag cross section and preferably include an M-shaped cross section. In this way, the slats are adapted to block light from entering a room, while allowing air to pass through the space between the slats. The blinds include a pull cable disposed on a roller for raising and lowering the blinds as desired by the user.

### CROSS REFERENCE TO RELATED APPLICATION

This application claims the benefit of U.S. Provisional Application No. 61/915,023 filed on Dec. 12, 2013. The above identified patent application is herein incorporated by reference in its entirety to provide continuity of disclosure.

### BACKGROUND OF THE INVENTION

1. Field of the Invention

The present invention relates to window blind apparatuses. More specifically, the present invention provides window blinds comprising a plurality of slats arranged in a horizontal orientation and disposed in a stacked orientation, wherein the slats include an M-shaped cross section adapted to allow air to pass through the spaces between the slats while preventing light from passing therethrough.

Conventional blinds include a plurality of rectangular slats that can be tilted so that the slats are disposed horizontally, or so that the slats are substantially vertical and contact one another in order to block light. However, when conventional blinds are tilted so as to block light, the blinds also prevent air from passing therethrough since the slats contact one another forming a solid barrier. Thus, a user is unable to allow air to flow into a room while also blocking light from outside of the window. Therefore, there is a need for a window blind apparatus that allows air to flow therethrough while simultaneously blocking light from outside of the window.

2. Description of the Prior Art

Devices have been disclosed in the prior art that relate to window blind apparatuses. These include devices that have been patented and published in patent application publications. These devices generally relate to window blinds comprising a series of slats arranged in a stacked configuration and adjustable so as to either allow light to pass therethrough or so as to block light from passing therethrough. The following is a list of devices deemed most relevant to the present disclosure, which are herein described for the purposes of highlighting and differentiating the unique aspects of the present invention, and further highlighting the drawbacks existing in the prior art.

One such device, U.S. Published Patent Application Number 2010/0263804 to Shprung discloses window blinds that allow air to pass therethrough but not light. The window blinds comprise several louvers positioned on top of one another. Each louver comprises two halves connected to one another by a cylindrical rod that serves as an axis, wherein the halves are positioned at an angle relative to one another. Thus, Shprung discloses a device wherein the orientation of each louver or slat is adjustable, and Shprung fails to disclose blinds having an M-shaped cross section.

U.S. Published Patent Application Number 2011/0192551 to Rance discloses a window blind assembly that allows a person inside of the room to see out of the room, but that prevents a person outside of the room from seeing into the room. The assembly includes alternating first and second slats wherein the first slats are semi-mirrored. A source of illumination is provided to illuminate the second slats, and so that light is reflected thereby towards the first slats. Thus, Rance fails to disclose window blinds that allow air to pass therethrough while preventing light from passing into a room.

U.S. Published Patent Application Number 2012/0234506 to Defenbaugh et al. discloses a slatted blind wherein the slats can be closed to create a light blocking blind. The slats can be supported by a tilt cord, and the slats are connected to the tilt cord so that when a slat is rotated to a closed position, the slat is suspended from the rung. A protrusion may be formed in the back of the slats such that the rung pushes on the protrusion to force the slat against an adjacent slat when the blind is closed. Thus, Defenbaugh fails to disclose window blinds that allow air to pass therethrough while preventing light from passing therethrough.

Finally, U.S. Published Patent Application Number 2004/0065418 to Colson discloses a covering for an architectural opening in the form of a Venetian blind. The device includes rungs that support slats in a horizontal orientation. The device includes guide cords that can be shifted vertically in order to cause the slats to tilt. The slats can be moved between a horizontal orientation and a substantially vertical orientation in order to block light. Thus, Colson fails to disclose window blinds that allow air to pass therethrough, but that prevents light from passing therethrough. Further, Colson fails to disclose blinds having a zig-zag or M-shaped cross section.

These prior art devices have several known drawbacks. Devices in the prior art generally relate to window blinds of various construction for preventing light from passing into a room. However, the devices are not adapted to allow air to flow through the blinds while simultaneously preventing light from passing therethrough. The prior art devices fail to disclose window blinds having rigid slats with a zig-zag or M-shaped cross section. Thus, the devices in the prior art are not suited for allowing air to flow therethrough while preventing light from shining into a room.

In light of the devices disclosed in the prior art, it is submitted that the present invention substantially diverges in design elements from the prior art and consequently it is clear that there is a need in the art for an improvement to existing window blind devices. In this regard the instant invention substantially fulfills these needs.

### SUMMARY OF THE INVENTION

In view of the foregoing disadvantages inherent in the known types of window blinds now present in the prior art, the present invention provides a new window blind apparatus wherein the same can be utilized for providing convenience for the user when allowing air to flow into a room while blocking light from outside of the window.

It is therefore an object of the present invention to provide a new and improved window blind apparatus that has all of the advantages of the prior art and none of the disadvantages.

It is another object of the present invention to provide a window blind apparatus comprising a zig-zag cross section so as to prevent light from passing therethrough.

Another object of the present invention is to provide a window blind apparatus comprising a plurality of slats arranged in a horizontal orientation, wherein there is space between each slat through which air can flow.

Yet another object of the present invention is to provide a window blind apparatus having a pull cord for raising and lowering the blinds as desired by the user.

Another object of the present invention is to provide a window blind apparatus that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the window blind apparatus of the present invention.

FIG. 2 shows a side view of an embodiment of the window blind apparatus of the present invention.

FIG. 3 shows a front planar view of the window blind apparatus of the present invention.

### DETAILED DESCRIPTION OF THE INVENTION

Reference is made herein to the attached drawings. Like reference numerals are used throughout the drawings to depict like or similar elements of the window blind apparatus. For the purposes of presenting a brief and clear description of the present invention, the preferred embodiment will be discussed as used for preventing sunlight from entering a room while allowing air to flow therethrough. The figures are intended for representative purposes only and should not be considered to be limiting in any respect.

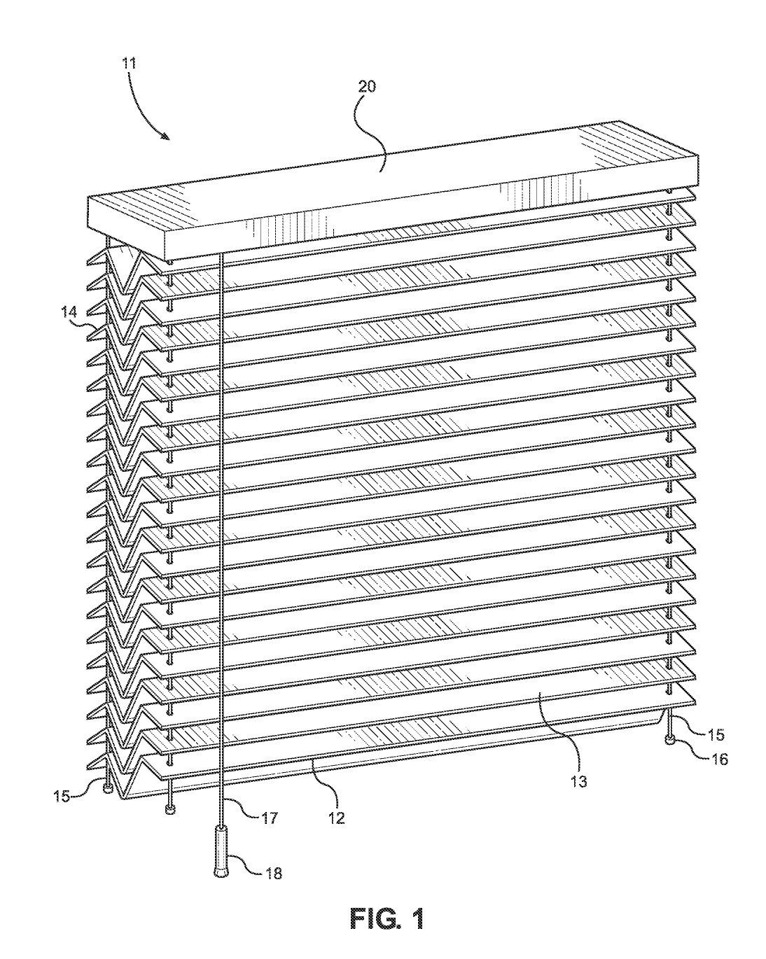

Referring now to FIG. 1, there is shown a perspective view of an embodiment of the window blind apparatus of the present invention. The present invention provides window blinds 11 comprising a plurality of slats 13. Each slat 13 is disposed in a horizontal orientation, and the slats 13 are arranged in a stacked orientation such that the slats 13 are vertically aligned. Each of the slats 13 comprises the same shape and dimensions so that the slats 13 are substantially identical. The slats 13 include a zig-zag cross section, wherein elongated rectangular members are connected to one another at an angle so as to form a zig-zag shape. Preferably, the slats 13 comprise an M-shaped cross section. The slats 13 are rigid and the shape of each slat 13 remains constant during use.

The uppermost portion of the window blinds 11 includes a housing 20 having a flat upper end with sidewalls extending downward therefrom. The housing 20 is adapted to enclose the rollers on which the cables required to raise and lower the plurality of slats 13 are positioned. This helps to prevent the rollers from being damaged and also conceals the rollers from view to provide an aesthetically pleasing appearance.

The slats 13 are connected to one another via a plurality of support cables 15 attached an one end to the housing. Preferably, a pair of support cables 15 are disposed on each end of the slats 13, wherein a first support cable 15 is on the front 12 of the slats 13, and a second support cable 15 is on the rear 14 of the slats 13. The support cables 15 are disposed in a vertical orientation and extend through apertures on each slat 13. The support cables 15 serve to organize and arrange the slats 13 and help to guide the slats 13 as they are raised or lowered. The slats 13 are spaced from one another at a fixed interval and are secured in fixed relation by means of stoppers 16 disposed along the support cables 15.

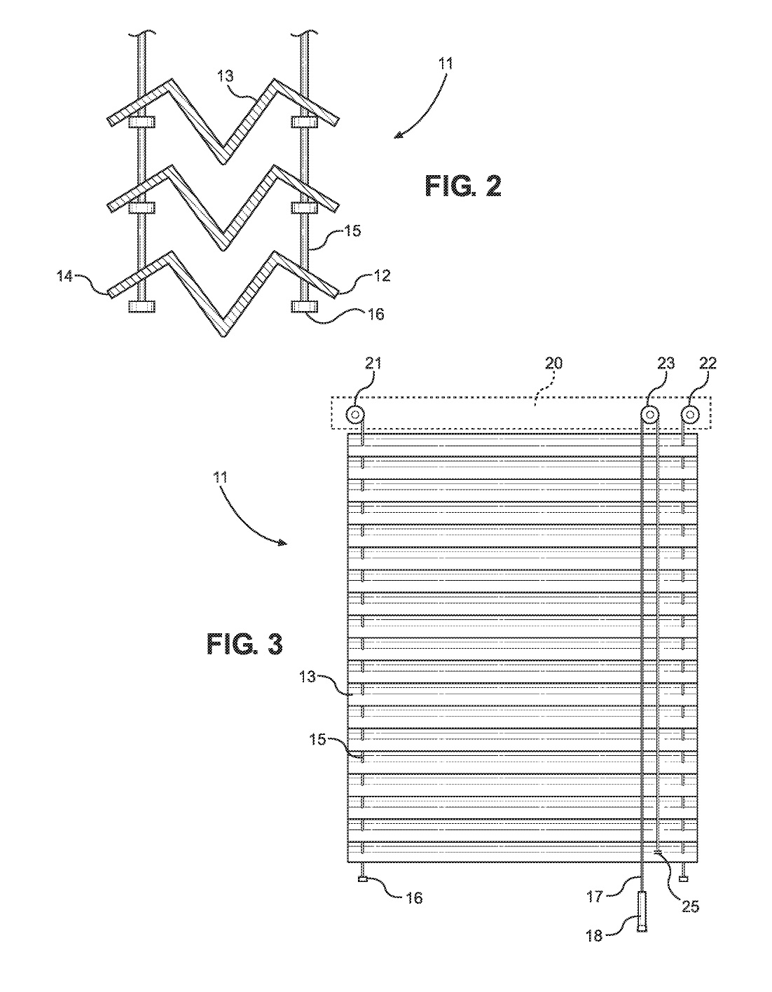

Referring now to FIG. 2, there is shown a side view of an embodiment of the window blinds device of the present invention. The slats 13 are disposed on support cables 15 on a front end 12 and rear end 14 thereof. Each slat 13 comprises apertures for the support cables 15 to pass through. The support cables 15 include stoppers 16 disposed at fixed intervals along the length thereof for separating the slats 13 to create space therebetween. Thus, the stoppers 16 are sized so as to be unable to pass through the apertures on the slats 13. The space between the slats 13 allows for air to flow therethrough so that when the blinds are in use, air can still flow through the blinds.

The slats 13 comprise a zig-zag cross section, and more preferably comprise an M-shaped cross section. The zig-zag cross section of the slats 13 helps to prevent light from passing through the blinds and into the room in which the window blinds 11 are installed. The M-shaped cross section provides three folds so that each slat 13 has four sections. The use of multiple sections helps to make the blinds opaque to prevent light from shining through the blinds. The slats 13 are arranged such that the front end 12 and rear end 14 thereof are angled downwards. This orientation further helps to block sunlight from the exterior of the window from passing through the window blinds 11.

Referring now to FIG. 3, there is shown a front planar view of the window blinds device of the present invention. The window blinds 11 of the present invention function similarly to traditional window blinds. The housing 20 encloses rollers 21, 22, 23 on which the cables used to support the slats 13 are positioned. In the illustrated embodiment, support cable rollers 21, 22 are positioned adjacent the ends of the housing 20 and have the support cables 15 disposed thereon. As the blinds are drawn upward so as to reveal the window, the support cable rollers 21, 22 wind the support cable 15 thereon to eliminate the slack in the support cables 15. The support cable rollers 21, 22 are spring biased so as to allow the rollers 21, 22 to wind the support cables 15 therearound. In alternate embodiments, the support cables 15 may be permanently affixed to the housing 20 at the upper ends thereof and no support cable rollers are used. In such embodiments, as the slats 13 are drawn to a closed position, the support cables 15 will bunch along the slats 13.

The housing 20 further encloses a pull cable roller 23. The pull cable roller 23 includes the pull cable 17 disposed thereon. The pull cable 17 includes a first end having a handle 18 thereon for a user to grasp when drawing the blinds open or closed, and the second end of the pull cable 17 is secured to the lowermost slat 13. In this way, when the user pulls the handle 18 of the pull cable 17, the lowermost slat 13 is drawn upward and pulls the other slats 13 upward so as to reveal the window. Additional pull cable rollers 23 may be used in order to evenly apply the pulling force along the length of the window blinds 11. The pull cable roller 23 may further include a locking mechanism so that the blinds can be maintained in a desired positioned, such as fully drawn or partially drawn. No statement is made regarding the exact configuration or number of rollers used to support the blinds.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A window blind apparatus, comprising:
a plurality of elongated slats disposed in a horizontal orientation and arranged in a stacked configuration;
wherein said plurality of slats are connected by one or more support cables extending vertically through said plurality of slats;
wherein said plurality of slats comprise a zig-zag cross section.

2) The window blind apparatus of claim 1, wherein said plurality of slots comprise an M-shaped cross section.

3) The window blind apparatus of claim 1, further comprising a housing in which one or more rollers are positioned, wherein said one or more rollers support said one or more support cables.

4) The window blind apparatus of claim 1, wherein an upper end of said one or more support cables is rigidly affixed to a housing disposed at an upper end of said plurality of slats.

5) The window blind apparatus of claim 1, further comprising a pull cable adapted to allow a user to raise and lower said plurality of slats.

6) The window blind apparatus of claim 5, wherein said pull cable includes a first end and a second end, wherein said first end includes a handle thereon and wherein said second end is attached to a lowermost slat, said pull cable disposed on a pull cable roller.

7) The window blind apparatus of claim 1, wherein said one or more support cables include stoppers disposed at fixed intervals thereon for supporting said plurality of slats in a spaced relationship to one another.
